(19) United States
(12) Patent Application Publication
(10) Pub. No.: US 2020/0012887 A1
(43) Pub. Date: Jan. 9, 2020

(54) ATTRIBUTE RECOGNITION APPARATUS AND METHOD, AND STORAGE MEDIUM

(71) Applicant: CANON KABUSHIKI KAISHA, Tokyo (JP)

(72) Inventors: Yan Li, Beijing (CN); Yaohai Huang, Beijing (CN); Xingyi Huang, Beijing (CN)

(21) Appl. No.: 16/459,372

(22) Filed: Jul. 1, 2019

(30) Foreign Application Priority Data
Jul. 4, 2018 (CN) 201810721890.3

(51) Int. Cl. G06K 9/62; G06N 3/04; G06N 3/08; G06N 20/20

(52) U.S. Cl. CPC G06K 9/6232; G06K 9/6277; G06N 20/20; G06N 3/0454; G06N 3/084; G06K 9/6259

(57) ABSTRACT

An attribute recognition apparatus including a unit for extracting a first feature from an image by using a feature extraction neural network; a unit for recognizing a first attribute of an object in the image based on the first feature by using a first recognition neural network; a unit for determining a second recognition neural network from a plurality of second recognition neural network candidates based on the first attribute; and a unit for recognizing at least one second attribute of the object based on the first feature by using a second recognition neural network.

### CROSS-REFERENCE TO RELATED APPLICATION

This application claims the benefit of Chinese Patent Application No. 201810721890.3, filed Jul. 4, 2018, which is hereby incorporated by reference herein in its entirety.

### BACKGROUND OF THE INVENTION

### Field of the Invention

The present invention relates to image processing, and more particularly to, for example, attribute recognition.

### Description of the Related Art

Since personal attributes can generally depict an appearance and/or a body shape of a person, person attribute recognition (especially, multi-tasking person attribute recognition) is generally used to perform monitoring processing such as crowd counting, identity verification, and the like. Here, the appearance includes, for example, age, gender, race, hair color, whether the person wears glasses, whether the person wears a mask, etc., and the body shape includes, for example, height, weight, and clothes worn by the person, whether the person carries a bag, whether the person pulls a suitcase, etc. Here, the multi-tasking person attribute recognition indicates that a plurality of attributes of one person are to be recognized at the same time. However, in the actual monitoring processing, since the variability and complexity of the monitoring scene usually cause a case where the illumination of the captured image is insufficient, a case where the face/body of the person in the captured image is occluded, or the like, it becomes an important part in the entire monitoring processing about how to maintain high recognition accuracy of the person attribute recognition in a variable monitoring scene.

As for variable and complex scenes, an exemplary processing method is disclosed in “Switching Convolutional Neural Network for Crowd Counting” (Deepak Babu Sam, Shiv Surya, R. Venkatesh Babu; IEEE Computer Society, 2017:4031-4039), which is mainly to estimate the crowd density in the image by using two neural networks independent of each other. Specifically, firstly, one neural network is used to determine a level corresponding to the crowd density in the image, where the level corresponding to the crowd density indicates a range of the number of persons that may exist at this level; secondly, one neural network candidate corresponding to the level is selected from a set of neural network candidates according to the determined level, where each neural network candidate among the set of neural network candidates corresponds to one level of the crowd density; and then, the actual crowd density in the image is estimated by using the selected neural network candidate, to ensure the accuracy of estimating the crowd density at different levels.

According to the above exemplary processing method, it can be seen that, as for the person attribute recognition at different scenes (i.e., variable and complex scenes), the accuracy of recognition can be improved by using two neural networks independent of each other. For example, at first, one neural network may be used to recognize a scene of an image, where the scene may be recognized, for example, by a certain attribute (e.g., whether or not a mask is worn) of a person in the image; and then, a neural network corresponding to the scene is selected to recognize a person attribute (e.g., age, gender, etc.) in the image. However, the scene recognition operation and the person attribute recognition operation respectively performed by using the two neural networks are independent of each other, and the result of the scene recognition operation is merely used to select a suitable neural network for the person attribute recognition operation to perform the corresponding recognition operation, but the mutual association and mutual influence that may exist between the two recognition operations are not considered, so that the entire recognition processing requires to take a long time.

### SUMMARY OF THE INVENTION

In view of the above recordation in the Description of the Related Art, the present disclosure is directed to solve at least one of the above issues.

According to one aspect of the present disclosure, there is provided an attribute recognition apparatus comprising: an extraction unit that extracts a first feature from an image by using a feature extraction neural network; a first recognition unit that recognizes a first attribute of an object in the image based on the first feature by using a first recognition neural network; a determination unit that determines a second recognition neural network from a plurality of second recognition neural network candidates based on the first attribute; and a second recognition unit that recognizes at least one second attribute of the object based on the first feature by using a second recognition neural network. Wherein, the first attribute is, for example, whether the object is occluded by an occluder.

According to another aspect of the present disclosure, there is provided an attribute recognition method comprising: an extracting step of extracting a first feature from an image by using a feature extraction neural network; a first recognizing step of recognizing a first attribute of an object in the image based on the first feature by using a first recognition neural network; a determination step of determining a second recognition neural network from a plurality of second recognition neural network candidates based on the first attribute; and a second recognizing step of recognizing at least one second attribute of the object based on the first feature by using a second recognition neural network.

Since the present disclosure extracts, for the subsequent first recognition operation and second recognition operation, a feature (i.e., a first feature) which they need to use commonly, by using a feature extraction neural network, redundant operations (for example, repeated extraction of features) between the first recognition operation and the second recognition operation can be greatly reduced, and further, the time required to be taken by the entire recognition processing can be greatly reduced.

Further features and advantages of the present disclosure will become apparent from the following description of typical embodiments with reference to the attached drawings.

### BRIEF DESCRIPTION OF THE DRAWINGS

The accompanying drawings, which are incorporated in and constitute a part of the specification, illustrate embodiments of the present disclosure and, together with the description of the embodiments, serve to explain the principles of the present disclosure.

FIG. 1 is a block diagram schematically illustrating a hardware configuration which can implement a technique according to an embodiment of the present disclosure.

FIG. 2 is a block diagram illustrating a configuration of an attribute recognition apparatus according to a first embodiment of the present disclosure.

FIG. 3 schematically illustrates a flow chart of an attribute recognition processing according to the first embodiment of the present disclosure.

FIG. 4 is a block diagram illustrating a configuration of an attribute recognition apparatus according to a second embodiment of the present disclosure.

FIG. 5 schematically illustrates a flow chart of an attribute recognition processing according to the second embodiment of the present disclosure.

FIG. 6 schematically illustrates a schematic process of generating a probability distribution map of a mask in the first generating step S321 illustrated in FIG. 5.

FIG. 7 schematically illustrates a flow chart of a generation method for generating a neural network that can be used in embodiments of the present disclosure.

### DESCRIPTION OF THE EMBODIMENTS

Exemplary embodiments of the present disclosure will be described below in detail with reference to the accompanying drawings. It should be noted that the following description is essentially merely illustrative and exemplary, and is in no way intended to limit the invention and its application or use. The relative arrangement of the components and steps, numerical expressions and numerical values set forth in the embodiments do not limit the scope of the invention, unless specifically stated otherwise. In addition, techniques, methods, and devices known by those skilled in the art may not be discussed in detail, but should be a part of the specification where appropriate.

It is noted that similar reference signs and characters refer to similar items in the drawings, and therefore, once one item is defined in one figure, it is not necessary to discuss this item in the following figures.

As for the object attribute recognition (for example, person attribute recognition) at different scenes, especially, the multi-tasking object attribute recognition, the inventor has found that the recognition operations for the scenes and/or the object attributes in an image are actually recognition operations performed on the same image for different purposes/tasks, thus these recognition operations will necessarily use certain features (for example, features that are identical or similar in semantics) in the image commonly. Therefore, the inventor believes that, before using a neural network (for example, “first recognition neural network” and “second recognition neural network” referred to hereinafter) to perform a corresponding recognition operation, if these features (for example, “first feature” and “shared feature” referred to hereinafter) can be extracted from the image at first by using a specific network (for example, “feature extraction neural network” referred to hereinafter) and then are used in subsequent recognition operations respectively, redundant operations (for example, repeated extraction of features) between the recognition operations can be greatly reduced, and further, the time required to be taken by the entire recognition processing can be greatly reduced.

Further, as for the multi-tasking object attribute recognition, the inventor has found that, when recognizing a certain attribute of an object, the features associated with this attribute will be mainly used. For example, when recognizing whether a person wears a mask, a feature that will be mainly used is, for example, a probability distribution of the mask. Moreover, the inventor has found that, when a certain attribute of the object has been recognized and other attributes of the object need to be subsequently recognized, if the feature associated with the attribute that has been already recognized can be removed so as to obtain, for example, “second feature” and “filtered feature” referred to hereinafter, the interference caused by the removed feature on the recognition of other attributes of the object can be reduced, thereby the accuracy of the entire recognition processing can be improved and the robustness of the object attribute recognition can be enhanced. For example, after recognizing that a person wears a mask, when it is still necessary to continue recognizing attributes, such as age, gender, etc., of the person, if the feature associated with the mask can be removed, the interference caused by the feature associated with the mask on the recognition of the attributes, such as age, gender, etc., can be reduced.

The present disclosure has been proposed in view of the findings described above and will be described below in detail with reference to the accompanying drawings.

(Hardware Configuration)

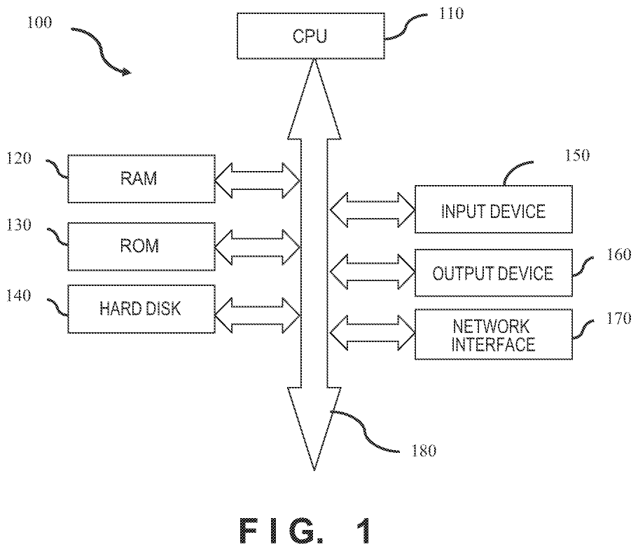

A hardware configuration which can implement the technique described below will be described at first with reference to FIG. 1.

The hardware configuration 100 includes, for example, a central processing unit (CPU) 110, a random access memory (RAM) 120, a read only memory (ROM) 130, a hard disk 140, an input device 150, an output device 160, a network interface 170, and a system bus 180. Further, the hardware configuration 100 may be implemented by, for example, a camera, a video camera, a personal digital assistant (PDA), a tablet, a laptop, a desktop, or other suitable electronic devices.

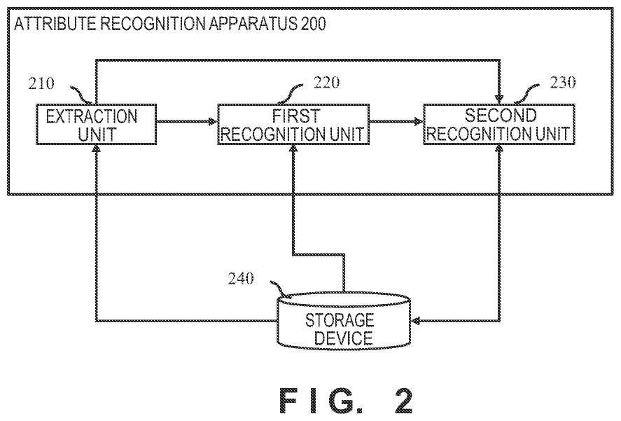

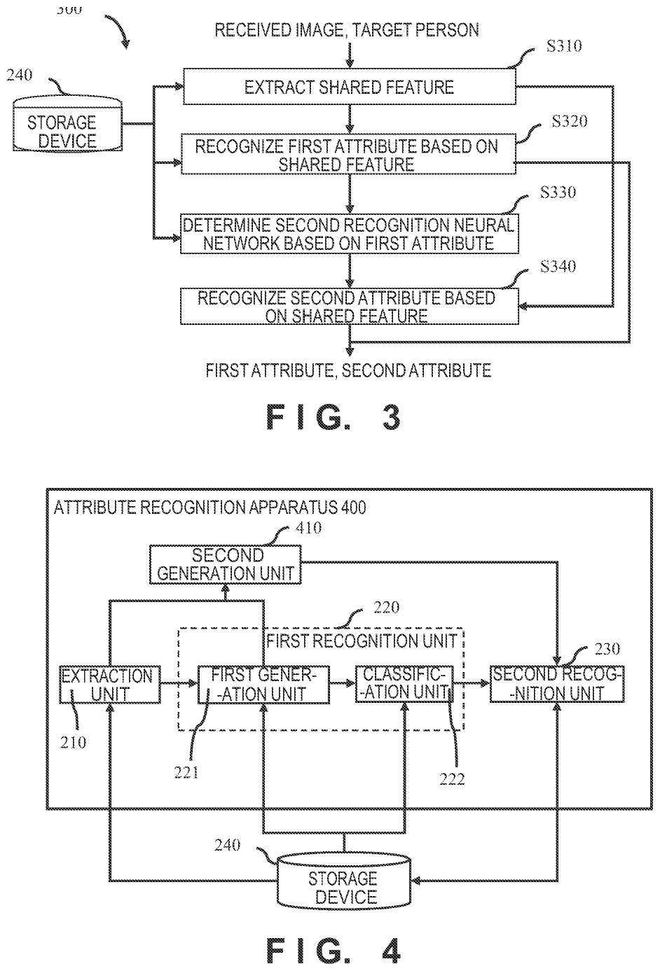

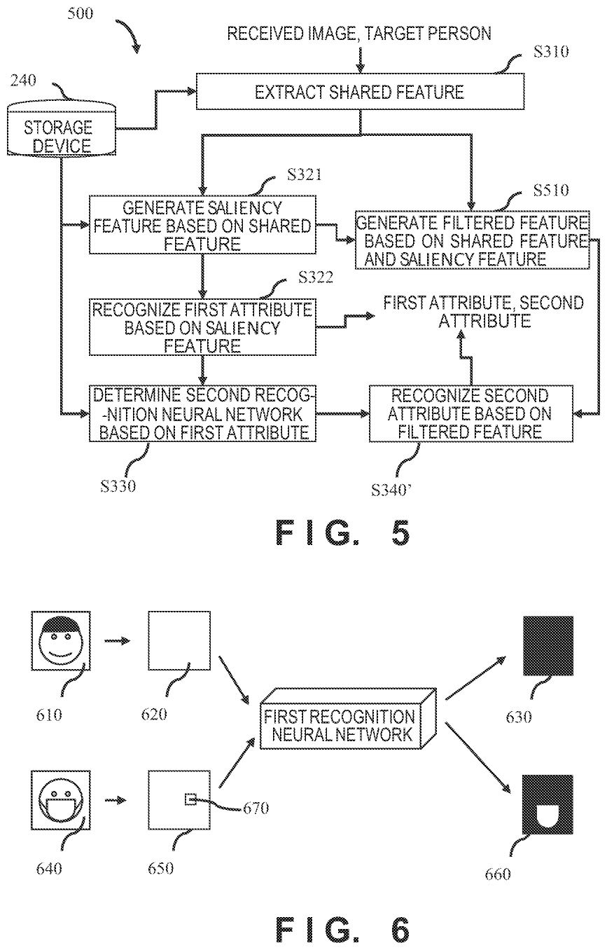

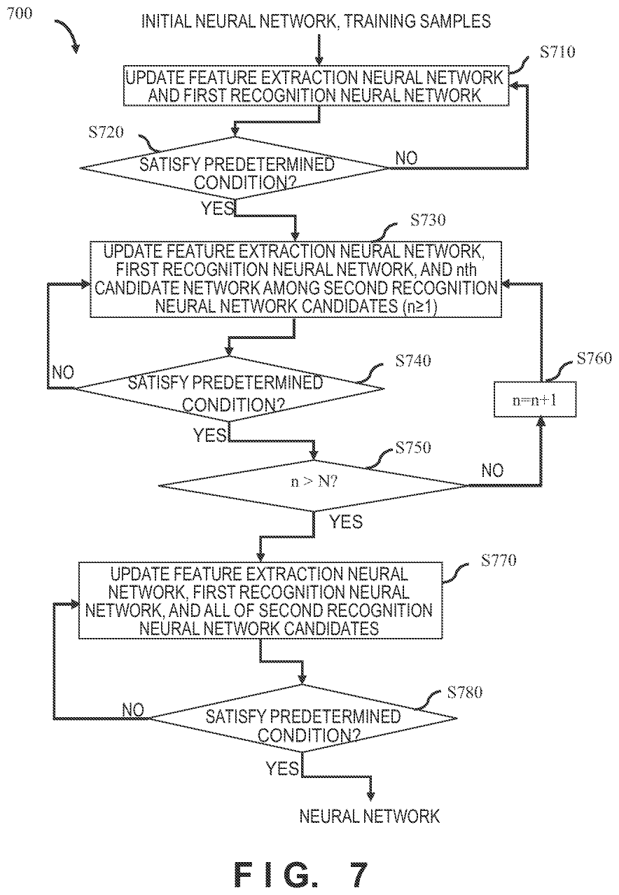

In one implementation, the attribute recognition according to the present disclosure is configured by hardware or firmware and functions as a module or a component of the hardware configuration 100. For example, the attribute recognition apparatus 200, which will be described below in detail with reference to FIG. 2, and the attribute recognition apparatus 400, which will be described below in detail with reference to FIG. 4, are used as modules or components of the hardware configuration 100. In another implementation, the attribute recognition according to the present disclosure is configured by software stored in the ROM 130 or the hard disk 140 and executed by the CPU 110. For example, the process 300, which will be described below in detail with reference to FIG. 3, the process 500, which will be described below in detail with reference to FIG. 5, and the process 700, which will be described below in detail with reference to FIG. 7, are used as programs stored in the ROM 130 or the hard disk 140.

The CPU 110 is any suitable programmable control device such as a processor, and may execute various functions to be described below by executing various application programs stored in the ROM 130 or the hard disk 140 (such as a memory). The RAM 120 is used to temporarily store program or data loaded from the ROM 130 or the hard disk 140, and is also used as a space in which the CPU 110 executes various processes (such as, carries out a technique which will be described below in detail with reference to FIGS. 3, 5 and 7) and other available functions. The hard disk 140 stores various information such as operating systems (OS), various applications, control programs, videos, images, pre-generated networks (e.g., neural networks), pre-defined data (e.g., thresholds (THs)), and the like.

In one implementation, the input device 150 is used to allow a user to interact with the hardware configuration 100. In one example, the user may input image/video/data through the input device 150. In another example, the user may trigger corresponding processing of the present disclosure through the input device 150. In addition, the input device 150 may adopt various forms, such as a button, a keyboard or a touch screen. In another implementation, the input device 150 is used to receive image/video output from specialized electronic devices such as digital camera, video camera, network camera, and/or the like.

In one implementation, the output device 160 is used to display a recognition result (such as, an attribute of an object) to the user. Moreover, the output device 160 may adopt various forms such as a cathode ray tube (CRT), a liquid crystal display, or the like.

The network interface 170 provides an interface for connecting the hardware configuration 100 to a network. For example, the hardware configuration 100 may perform data communication, via the network interface 170, with another electronic device connected via the network.

Alternatively, the hardware configuration 100 may be provided with a wireless interface to perform wireless data communication. The system bus 180 may provide a data transmission path for transmitting data among the CPU 110, the RAM 120, the ROM 130, the hard disk 140, the input device 150, the output device 160, the network interface 170, and the like to one another. Although being referred to as a bus, the system bus 180 is not limited to any particular data transmission technique.

The hardware configuration 100 described above is merely illustrative and is in no way intended to limit the invention and its application or use. Moreover, for the sake of brevity, only one hardware configuration is illustrated in FIG. 1. However, a plurality of hardware configurations may also be used as needed.

(Attribute Recognition)

Next, the attribute recognition according to the present disclosure will be described with reference to FIGS. 2 to 6.

FIG. 2 is a block diagram illustrating a configuration of an attribute recognition apparatus 200 according to a first embodiment of the present disclosure. Here, some or all of the modules illustrated in FIG. 2 may be implemented by dedicated hardware. As illustrated in FIG. 2, the attribute recognition apparatus 200 includes an extraction unit 210, a first recognition unit 220 and a second recognition unit 230. The attribute recognition apparatus 200 can be used, for example, at least to recognize an attribute of the face of a person (i.e., the appearance of the person) and an attribute of the clothes worn by the person (i.e., the body shape of the person). However, it is obviously not necessary to be limited thereto.

In addition, the storage device 240 illustrated in FIG. 2 stores a pre-generated feature extraction neural network to be used by the extraction unit 210, a pre-generated first recognition neural network to be used by the first recognition unit 220, and a pre-generated second recognition neural network (i.e., each second recognition neural network candidate) to be used by the second recognition unit 230. Here, a method of generating each neural network that can be used in embodiments of the present disclosure will be described below in detail with reference to FIG. 7. In one implementation, the storage device 240 is the ROM 130 or the hard disk 140 illustrated in FIG. 1. In another implementation, the storage device 240 is a server or an external storage device that is connected to the attribute recognition apparatus 200 via a network (not illustrated). In addition, alternatively, these pre-generated neural networks may be stored in different storage devices.

Firstly, the input device 150 illustrated in FIG. 1 receives an image that is output from a specialized electronic device (e.g., a video camera or the like) or input by a user. Next, the input device 150 transmits the received image to the attribute recognition apparatus 200 via the system bus 180.

Then, as illustrated in FIG. 2, the extraction unit 210 acquires the feature extraction neural network from the storage device 240, and extracts the first feature from the received image by using the feature extraction neural network. In other words, the extraction unit 210 extracts the first feature from the image by a multi-layer convolution operation. Hereinafter, this first feature will be referred to as a “shared feature” for example. The shared feature is a multi-channel feature, and includes at least an image scene feature and an object attribute feature (person attribute feature) for example.

The first recognition unit 220 acquires the first recognition neural network from the storage device 240, and recognizes the first attribute of an object in the received image based on the shared feature extracted by the extraction unit 210 by using the first recognition neural network. Here, the first attribute of the object is, for example, whether the object is occluded by an occluder (e.g., whether the face of the person is occluded by a mask, whether the clothes worn by the person are occluded by another object, etc.).

The second recognition unit 230 acquires the second recognition neural network from the storage device 240, and recognizes at least one second attribute (e.g., age of person, gender of person, and/or the like) of the object based on the shared feature extracted by the extraction unit 210 by using the second recognition neural network. Here, one second recognition neural network candidate is determined from a plurality of second recognition neural network candidates stored in the storage device 240 as the second recognition neural network that can be used by the second recognition unit 230, based on the first attribute recognized by the first recognition unit 220. In one implementation, the determination of the second recognition neural network can be implemented by the second recognition unit 230. In another implementation, the determination of the second recognition neural network can be implemented by a dedicated selection unit or determination unit (not illustrated).

Finally, the first recognition unit 220 and the second recognition unit 230 transmit the recognition results (e.g., the recognized first attribute of the object, and the recognized second attribute of the object) to the output device 160 via the system bus 180 illustrated in FIG. 1 for displaying the recognized attributes of the object to the user.

Here, the recognition processing performed by the attribute recognition apparatus 200 may be regarded as a multi-tasking object attribute recognition processing. For example, the operation executed by the first recognition unit 220 may be regarded as a recognition operation of a first task, and the operation executed by the second recognition unit 230 may be regarded as a recognition operation of a second task. The second recognition unit 230 can recognize a plurality of attributes of the object.

Here, what the attribute recognition apparatus 200 recognizes is an attribute of one object of the received image. In the case where a plurality of objects (e.g., a plurality of persons) are included in the received image, all of the objects in the received image may be detected at first, and then, for each of the objects, the attribute thereof may be recognized by the attribute recognition apparatus 200.

The flowchart 300 illustrated in FIG. 3 is a corresponding process of the attribute recognition apparatus 200 illustrated in FIG. 2. In FIG. 3, a description will be made by taking an example of recognizing a face attribute of one target person in the received image, where the first attribute required to be recognized is, for example, whether the face of the target person is occluded by a mask, and the second attribute required to be recognized is, for example, the age of the target person. However, it is obviously not necessary to be limited thereto. In addition, the object that occludes the face is obviously not necessary to be limited to the mask, but may be another occluder.

As illustrated in FIG. 3, in the extracting step S310, the extraction unit 210 acquires the feature extraction neural network from the storage device 240, and extracts the shared feature from the received image using the feature extraction neural network.

In the first recognizing step S320, the first recognition unit 220 acquires the first recognition neural network from the storage device 240, and recognizes the first attribute of the target person, i.e., whether the face of the target person is occluded by a mask, based on the shared feature extracted from the extracting step S310 by using the first recognition neural network. In an implementation, the first recognition unit 220 acquires at first a scene feature of the region where the target person is located from the shared feature, and then obtains a probability value (for example, P(M₁)) that the face of the target person is occluded by the mask and a probability value (for example, P(M₂)) that the face of the target person is not occluded by the mask based on the acquired scene feature by using the first recognition neural network, and after this, selects the attribute with the largest probability value as the first attribute of the target person, where P(M₁)+P(M₂)=1. For example, in the case of P(M₁)>P(M₂), the first attribute of the target person is that the face is occluded by the mask, and the confidence of the first attribute of the target person at this time is Pₜₐₛₖ₁=P(M₁); and in the case of P(M₁)<P(M₂), the first attribute of the target person is that the face is not occluded by the mask, and the confidence of the first attribute of the target person at this time is Pₜₐₛₖ₁=P(M₂).

In step S330, for example, the second recognition unit 230 determines one second recognition neural network candidate from the plurality of second recognition neural network candidates stored in the storage device 240 as the second recognition neural network that can be used by the second recognition unit 230, based on the first attribute of the target person. For example, in the case where the first attribute of the target person is that the face is occluded by the mask, the second recognition neural network candidate trained through the training samples of the face wearing a mask will be determined as the second recognition neural network. On the contrary, in the case where the first attribute of the target person is that the face is not occluded by the mask, the second recognition neural network candidate trained through the training samples of the face not wearing a mask will be determined as the second recognition neural network. Obviously, in the case where the first attribute of the target person is another attribute, for example, whether the clothes worn by the person are occluded by another object, the second recognition neural network candidate corresponding to the attribute may be determined as the second recognition neural network.

In the second recognizing step S340, the second recognition unit 230 recognizes the second attribute of the target person, i.e., the age of the target person, based on the shared feature extracted from the extracting step S310 by using the determined second recognition neural network. In one implementation, the second recognition unit 230 acquires at first the person attribute feature of the target person from the shared feature, and then recognizes the second attribute of the target person based on the acquired person attribute feature by using the second recognition neural network.

Finally, the first recognition unit 220 and the second recognition unit 230 transmit the recognition results (e.g., whether the target person is occluded by a mask, and the age of the target person) to the output device 160 via the system bus 180 illustrated in FIG. 1 for displaying the recognized attributes of the target person to the user.

Further, as described above, in the multi-tasking object attribute recognition, as for the attribute that has been already recognized, if the feature associated with the recognized attribute can been removed, the interference caused by this feature on the subsequent recognition of the second attribute can be reduced, thereby the accuracy of the entire recognition processing can be improved and the robustness of the object attribute recognition can be enhanced. Thus, FIG. 4 is a block diagram illustrating a configuration of an attribute recognition apparatus 400 according to a second embodiment of the present disclosure. Here, some or all of the modules illustrated in FIG. 4 can be implemented by dedicated hardware. Compared to the attribute recognition apparatus 200 illustrated in FIG. 2, the attribute recognition apparatus 400 illustrated in FIG. 4 further includes a second generation unit 410, and the first recognition unit 220 includes a first generation unit 221 and a classification unit 222.

As illustrated in FIG. 4, after the extraction unit 210 extracts the shared feature from the received image by using the feature extraction neural network, the first generation unit 221 acquires the first recognition neural network from the storage device 240, and generates a feature associated with the first attribute of the object to be recognized based on the shared feature extracted by the extraction unit 210 by using the first recognition neural network. Hereinafter, the feature associated with the first attribute of the object to be recognized will be referred to as a “saliency feature” for example. Here, in the case where the first attribute of the object to be recognized is whether the object is occluded by an occluder, the generated saliency feature may embody a probability distribution of the occluder. For example, in the case where the first attribute of the object to be recognized is whether the face of the person is occluded by a mask, the generated saliency feature may be a probability distribution map/heat map of the mask. For example, in the case where the first attribute of the object to be recognized is whether the clothes worn by the person are occluded by another object, the generated saliency feature may be a probability distribution map/heat map of the object occluding the clothes. In addition, as described in the above first embodiment, the shared feature extracted by the extraction unit 210 is a multi-channel feature, and the saliency feature generated by the first generation unit 221 embodies the probability distribution of the occluder, thereby it can be seen that the operation performed by the first generation unit 221 is equivalent to an operation of feature compression (that is, an operation of converting a multi-channel feature into a single-channel feature).

After the first generation unit 221 generates the saliency feature, on the one hand, the classification unit 222 recognizes the first attribute of the object to be recognized based on the saliency feature generated by the first generation unit 221 using the first recognition neural network. Here, the first recognition neural network used by the first recognition unit 220 (that is, the first generation unit 221 and the classification unit 222) in the present embodiment may be used to generate the saliency feature in addition to recognizing the first attribute of the object, and the first recognition neural network that can be used in the present embodiment may also be similarly obtained by referring to the generation method of each neural network described with reference to FIG. 7.

On the other hand, the second generation unit 410 generates a second feature based on the shared feature extracted by the extraction unit 210 and the saliency feature generated by the first generation unit 221. Here, the second feature is a feature associated with a second attribute of the object to be recognized by the second recognition unit 230. In other words, the operation performed by the second generation unit 410 is to perform a feature filtering operation on the shared feature extracted by the extraction unit 210 by using the saliency feature generated by the first generation unit 221, so as to remove the feature associated with the first attribute of the object (that is, remove the feature associated with the attribute that has been already recognized). Thus, hereinafter, the generated second feature will be referred to as a “filtered feature” for example.

After the second generation unit 410 generates the filtered feature, the second recognition unit 230 recognizes the second attribute of the object based on the filtered feature by using the second recognition neural network.

In addition, since the extraction unit 210 and the second recognition unit 230 illustrated in FIG. 4 are the same as the corresponding units illustrated in FIG. 2, the detailed description will not be repeated here.

The flowchart 500 illustrated in FIG. 5 is a corresponding process of the attribute recognition apparatus 400 illustrated in FIG. 4. Here, compared to the flowchart 300 illustrated in FIG. 3, the flowchart 500 illustrated in FIG. 5 further includes a second generating step S510, and a first generating step S321 and a classifying step S322 are included in the first recognizing step S320 illustrated in FIG. 3. In addition, the second recognizing step S340′ illustrated in FIG. 5 is different from the second recognizing step S340 illustrated in FIG. 3 in the point of input features. In FIG. 6, a description will be made also by taking an example of recognizing a face attribute of one target person in the received image, where the first attribute required to be recognized is, for example, whether the face of the target person is occluded by a mask, and the second attribute required to be recognized is, for example, the age of the target person. However, it is obviously not necessary to be limited thereto. In addition, the object that occludes the face is obviously not necessary to be limited to the mask, but may be another occluder.

As illustrated in FIG. 5, after the extraction unit 210 extracts the shared feature from the received image by using the feature extraction neural network in the extracting step S310, in the first generating step S321, the first generation unit 221 acquires the first recognition neural network from the storage device 240, and generates the probability distribution map/heat map of the mask (i.e., the saliency feature) based on the shared feature extracted in the extracting step S310 by using the first recognition neural network. Hereinafter, a description will be made by taking an example of the probability distribution map of the mask. FIG. 6 schematically illustrates a schematic process of generating a probability distribution map of a mask. As illustrated in FIG. 6, in the case where the face of the target person is not occluded by the mask, the received image is, for example, as indicated by 610, the shared feature extracted from the received image is, for example, as indicated by 620, and after the shared feature 620 is passed through the first recognition neural network, the generated probability distribution map of the mask is, for example, as indicated by 630. In the case where the face of the target person is occluded by the mask, the received image is, for example, as indicated by 640, the shared feature extracted from the received image is, for example, as indicated by 650, and after the shared feature 650 is passed through the first recognition neural network, the generated probability distribution map of the mask is, for example, as indicated by 660. In one implementation, the first generation unit 221 acquires at first a scene feature of the region where the target person is located from the shared feature, and then generates the probability distribution map of the mask based on the acquired scene feature by using the first recognition neural network.

After the first generation unit 221 generates the probability distribution map of the mask in the first generating step S321, on the one hand, in the classifying step S322, the classification unit 222 recognizes the first attribute of the target person (i.e., whether the face of the target person is occluded by a mask) based on the probability distribution map of the mask generated in the first generating step S321 by using the first recognition neural network. Since the operation of the classifying step S322 is similar to the operation of the first recognizing step S320 illustrated in FIG. 3, the detailed description will not be repeated here.

On the other hand, in the second generating step S510, the second generation unit 410 generates a filtered feature (that is, the feature associated with the mask is removed from this feature) based on the shared feature extracted in the extracting step S310 and the probability distribution map of the mask generated in the first generating step S321. In one implementation, as for each pixel block (e.g., pixel block 670 as illustrated in FIG. 6) in the shared feature, the second generation unit 410 obtains a corresponding filtered pixel block by performing a mathematical operation (for example, a multiplication operation) on the pixel matrix of the pixel block with the pixel matrix of the pixel block in the probability distribution map of the mask at the same position, thereby finally obtaining the filtered feature.

After the second generation unit 410 generates the filtered feature in the second generating step S510, on the one hand, in step S330, for example, the second recognition unit 230 determines the second recognition neural network that can be used by the second recognition unit 230 based on the first attribute of the target person. Since the operation of step S330 here is the same as the operation of step S330 illustrated in FIG. 3, the detailed description will not be repeated here. On the other hand, in the second recognizing step S340′, the second recognition unit 230 recognizes the second attribute of the target person (i.e., the age of the target person) based on the filtered feature generated in the second generating step S510 by using the determined second recognition neural network. Since except that the input feature is replaced from a shared feature to a filtered feature, the rest operations in the second recognizing step S340′ here and the second recognizing step S340 illustrated in FIG. 3 are the same, the detailed description will not be repeated here.

In addition, since the extracting step S310 illustrated in FIG. 5 is the same as the corresponding step illustrated in FIG. 3, the detailed description will not be repeated here.

As described above, according to the present disclosure, on the one hand, before a multi-tasking object attribute recognition is performed, the present disclosure may extract at first a feature (i.e., a “shared feature”), which needs to be used commonly when recognizing each attribute, from the image by using a specific network (i.e., the “feature extraction neural network”), thereby redundant operations between the attribute recognition operations can be greatly reduced, and further, the time required to be taken by the entire recognition processing can be greatly reduced. On the other hand, when a certain attribute (e.g., the first attribute) of the object has been recognized and other attributes (e.g., the second attribute) of the object need to be subsequently recognized, the present disclosure may remove at first the feature associated with the attribute that has been already recognized from the shared feature so as to obtain the “filtered feature”, and then the interference caused by the removed feature on the recognition of other attributes of the object can be reduced, thereby the accuracy of the entire recognition processing can be improved and the robustness of the object attribute recognition can be enhanced.

(Generation of Neural Network)

In order to generate a neural network that can be used in the first embodiment and the second embodiment of the present disclosure, a corresponding neural network may be generated in advance based on a preset initial neural network and training samples by using the generation method described with reference to FIG. 7. The generation method described with reference to FIG. 7 may also be executed by the hardware configuration 100 illustrated in FIG. 1.

In one implementation, in order to increase the convergence and stability of the neural network, FIG. 7 schematically illustrates a flowchart 700 of a generation method for generating a neural network that can be used in embodiments of the present disclosure.

First, as illustrated in FIG. 7, the CPU 110 as illustrated in FIG. 1 acquires, through the input device 150, a preset initial neural network and training samples which are labeled with the first attribute of the object (for example, whether the object is occluded by an occluder). For example, in the case where the first attribute of the object is whether the face of the person is occluded by an occluder (e.g., a mask), the training samples to be used include training samples in which the face is occluded and training samples in which the face is not occluded. In the case where the first attribute of the object is whether the clothes worn by the person are occluded by an occluder, the training samples to be used include training samples in which the clothes are occluded and training samples in which the clothes are not occluded.

Then, in step S710, the CPU 110 updates the feature extraction neural network and the first recognition neural network simultaneously based on the acquired training samples in a manner of back propagation.

In one implementation, as for the first embodiment of the present disclosure, firstly, the CPU 110 passes the currently acquired training samples through the current “feature extraction neural network” (e.g., the initial “feature extraction neural network”) to obtain a “shared feature”, and passes the “shared feature” through the current “first recognition neural network” (e.g., the initial “first recognition neural network”) to obtain a predicted probability value for the first attribute of the object. For example, in the case where the first attribute of the object is whether the face of the person is occluded by an occluder, the obtained predicted probability value is a predicted probability value that the face of the person is occluded by the occluder. Secondly, the CPU 110 determines a loss between the predicted probability value and the true value for the first attribute of the object, which may be represented as Lₜₐₛₖ₁ for example, by using loss functions (e.g., Softmax Loss function, Hinge Loss function, Sigmoid Cross Entropy function, etc.). Here, the true value for the first attribute of the object may be obtained according to the corresponding labels in the currently acquired training samples. Again, the CPU 110 updates the parameters of each layer in the current “feature extraction neural network” and the current “first recognition neural network” based on the loss Lₜₐₛₖ₁ in the manner of back propagation, where the parameters of each layer here are, for example, the weight values in each convolutional layer in the current “feature extraction neural network” and the current “first recognition neural network”. In one example, the parameters of each layer are updated based on the loss Lₜₐₛₖ₁ by using a stochastic gradient descent method for example.

In another implementation, as for the second embodiment of the present disclosure, firstly, the CPU 110 passes the currently acquired training samples through the current “feature extraction neural network” (e.g., the initial “feature extraction neural network”) to obtain the “shared feature”, passes the “shared feature” through the current “first recognition neural network” (e.g., the initial “first recognition neural network”) to obtain a “saliency feature” (e.g., a probability distribution map of the occluder), and passes the “saliency feature” through the current “first recognition neural network” to obtain the predicted probability value for the first attribute of the object. Here, the operation of passing through the current “first recognition neural network” to obtain the “saliency feature” can be realized by using a weak supervised learning algorithm. Secondly, as described above, the CPU 110 determines the loss Lₜₐₛₖ₁ between the predicted probability value and the true value for the first attribute of the object, and updates the parameters of each layer in the current “feature extraction neural network” and the current “first recognition neural network” based on the loss Lₜₐₛₖ₁.

Returning to FIG. 7, in step S720, the CPU 110 determines whether the current “feature extraction neural network” and the current “first recognition neural network” satisfy a predetermined condition. For example, after the number of updates for the current “feature extraction neural network” and the current “first recognition neural network” reaches a predetermined number of times (e.g., X times), it is considered that the current “feature extraction neural network” and the current “first recognition neural network” have satisfied the predetermined condition, and then the generation process proceeds to step S730, otherwise, the generation process re-proceeds to step S710. However, it is obviously not necessary to be limited thereto.

As a replacement of the steps S710 and S720, for example, after the loss Lₜₐₛₖ₁ is determined, the CPU 110 compares the determined Lₜₐₛₖ₁ with a threshold (e.g., TH1). In the case where Lₜₐₛₖ₁ is less than or equal to TH1, the current “feature extraction neural network” and the current “first recognition neural network” are determined to have satisfied the predetermined condition, and then the generation process proceeds to other update operations (for example, step S730), otherwise, the CPU 110 updates the parameters of each layer in the current “feature extraction neural network” and the current “first recognition neural network” based on the loss Lₜₐₛₖ₁. After this, the generation process re-proceeds to the operation of updating the feature extraction neural network and the first recognition neural network (e.g., step S710).

Returning to FIG. 7, in step S730, as for the n^{th} candidate network (for example, the 1^{st} candidate network) among the second recognition neural network candidates, wherein how many categories of the first attribute of the object are there, how many second recognition neural network candidates are there correspondingly. For example, in the case where the first attribute of the object is whether the face of the person is occluded by an occluder (e.g., a mask), the number of categories of the first attribute of the object is 2, that is, one category is “occluded” and the other category is “not occluded”, and there are two second recognition neural network candidates correspondingly. The CPU 110 updates the n^{th} candidate network, the feature extraction neural network and the first recognition neural network simultaneously in the manner of back propagation, based on the acquired training samples in which labels correspond to one category of the first attribute of the object (e.g., training samples in which the face is occluded).

In one implementation, as for the first embodiment of the present disclosure, firstly, on the one hand, the CPU 110 passes the currently acquired training samples through the current “feature extraction neural network” (e.g., the “feature extraction neural network” updated via step S710) to obtain the “shared feature”, and passes the “shared feature” through the current “first recognition neural network” (e.g., the “first recognition neural network” updated via step S710) to obtain the predicted probability value for the first attribute of the object, for example, the predicted probability value that the face of the person is occluded by the occluder, as described above for step S710. On the other hand, the CPU 110 passes the “shared feature” through the current “n^{th} candidate network” (e.g., the initial “n^{th} candidate network”) to obtain a predicted probability value for the second attribute of the object, wherein how many second attributes that need to be recognized via the n^{th} candidate network are there, how many corresponding predicted probability values are there. Secondly, on the one hand, the CPU 110 determines the loss (which may be represented as Lₜₐₛₖ₁ for example) between the predicted probability value and the true value for the first attribute of the object and the loss (which may be represented as Lₜₐₛₖ₋ₒₜₕₑᵣₛ for example) between the predicted probability value and the true value for the second attribute of the object respectively by using loss functions. Here, the true value for the second attribute of the object may also be obtained according to the corresponding labels in the currently acquired training samples. On the other hand, the CPU 110 calculates a loss sum (which may be represented as L1 for example), that is, the loss sum L1 is the sum of the loss Lₜₐₛₖ₁ and the loss Lₜₐₛₖ₋ₒₜₕₑᵣₛ. That is, the loss sum L1 may be obtained by the following formula (1):

L1=Lₜₐₛₖ₁+Lₜₐₛₖ₋ₒₜₕₑᵣₛ (1)

Furthermore, the CPU 110 updates the parameters of each layer in the current “n^{th} candidate network”, the current “feature extraction neural network”, and the current “first recognition neural network” based on the loss sum L1 in the manner of back propagation.

In another implementation, as for the second embodiment of the present disclosure, firstly, on the one hand, the CPU 110 passes the currently acquired training samples through the current “feature extraction neural network” (e.g., the “feature extraction neural network” updated via step S710) to obtain the “shared feature”, passes the “shared feature” through the current “first recognition neural network” (e.g., the “first recognition neural network” updated via step S710) to obtain the “saliency feature”, and passes the “saliency feature” through the current “first recognition neural network” to obtain the predicted probability value for the first attribute of the object. On the other hand, the CPU 110 performs a feature filtering operation on the “shared feature” by using the “saliency feature” to obtain a “filtered feature”, and passes the “filtered feature” through the current “n^{th} candidate network” to obtain the predicted probability value for the second attribute of the object.

Secondly, as described above, the CPU 110 determines each loss and calculates the loss sum L1, and updates the parameters of each layer in the current “n^{th} candidate network”, the current “feature extraction neural network”, and the current “first recognition neural network” based on the loss sum L1.

Returning to FIG. 7, in step S740, the CPU 110 determines whether the current “n^{th} candidate network”, the current “feature extraction neural network”, and the current “first recognition neural network” satisfy a predetermined condition. For example, after the number of updates for the current “n^{th} candidate network”, the current “feature extraction neural network” and the current “first recognition neural network” reaches a predetermined number of times (e.g., Y times), it is considered that the current “n^{th} candidate network”, the current “feature extraction neural network” and the current “first recognition neural network” have satisfied the predetermined condition, and then the generation process proceeds to step S750, otherwise, the generation process re-proceeds to step S730. However, it is obviously not necessary to be limited thereto. It is also possible to determine whether each of the current neural networks satisfies a predetermined condition based on the calculated loss sum L1 and a predetermined threshold (e.g., TH2), as described above in the replacement solutions for the steps S710 and S720. Since the corresponding determination operations are similar, the detailed description will not be repeated here.

As described above, how many categories of the first attribute of the object are there, how many second recognition neural network candidates are there correspondingly. Assuming that the number of categories of the first attribute of the object is N, in step S750, the CPU 110 determines whether all of the second recognition neural network candidates are updated, that is, determines whether n is greater than N. In the case of n>N, the generation process proceeds to step S770. Otherwise, in step S760, the CPU 110 sets n=n+1, and the generation process re-proceeds to step S730.

In step S770, the CPU 110 updates each of the second recognition neural network candidates, the feature extraction neural network, and the first recognition neural network simultaneously based on the acquired training samples in the manner of back propagation.

In one implementation, as for the first embodiment of the present disclosure, firstly, on the one hand, the CPU 110 passes the currently acquired training samples through the current “feature extraction neural network” (e.g., the “feature extraction neural network” updated via step S730) to obtain the “shared feature”, and passes the “shared feature” through the current “first recognition neural network” (e.g., the “first recognition neural network” updated via step S730) to obtain the predicted probability value for the first attribute of the object, for example, the predicted probability value that the face of the person is occluded by the occluder, as described above for step S710. On the other hand, as for each candidate network among the second recognition neural network candidates, the CPU 110 passes the “shared feature” through the current candidate network (e.g., the candidate network updated via step S730) to obtain a predicted probability value for the second attribute of the object under this candidate network. Secondly, on the one hand, the CPU 110 determines the loss (which may be represented as Lₜₐₛₖ₁ for example) between the predicted probability value and the true value for the first attribute of the object and the loss (which may be represented as Lₐₛₖ₋ₒₜₕₑᵣₛ₍ₙ₎ for example) between the predicted probability value and the true value for the second attribute of the object under each candidate network respectively by using loss functions. Here, Lₐₛₖ₋ₒₜₕₑᵣₛ₍ₙ₎ represents a loss between the predicted probability value and the true value for the second attribute of the object under the n^{th} candidate network. On the other hand, the CPU 110 calculates a loss sum (which may be represented as L2 for example), that is, the loss sum L2 is the sum of the loss Lₜₐₛₖ₁ and the loss Lₜₐₛₖ₋ₒₜₕₑᵣₛ₍ₙ₎. That is, the loss sum L2 may be obtained by the following formula (2):

L2=Lₜₐₛₖ₁+Lₜₐₛₖ₋ₒₜₕₑᵣₛ₍₁₎+ . . . +Lₜₐₛₖ₋ₒₜₕₑᵣₛ₍ₙ₎+ . . . +L_{task-others(N)} (2)

As a replacement, in order to obtain a more robust neural network, Lₜₐₛₖ₋ₒₜₕₑᵣₛ₍ₙ₎ may be weighted based on the obtained predicted probability value for the first attribute of the object during the process of calculating the loss sum L2 (that is, the obtained predicted probability value for the first attribute of the object may be used as a parameter for Lₜₐₛₖ₋ₒₜₕₑᵣₛ₍ₙ₎), such that the accuracy of the prediction of the second attribute of the object can be maintained even in the case where an error occurs in the prediction of the first attribute of the object. For example, taking an example that the first attribute of the object is whether the face of the person is occluded by an occluder, and assuming that the obtained predicted probability value that the face of the person is occluded by the occluder is P(C), the predicted probability value that the face of the person is not occluded by the occluder may be obtained to be 1-P(C), thereby the loss sum L2 may be obtained by the following formula (3):

L3=Lₜₐₛₖ₁+P(C)*Lₜₐₛₖ₋ₒₜₕₑᵣₛ₍₁₎+(1−P(C))*Lₜₐₛₖ₋ₒₜₕₑᵣₛ₍₂₎ (3)

Where, Lₜₐₛₖ₋ₒₜₕₑᵣₛ₍₁₎ represents a loss between the predicted probability value and the true value for the second attribute of the person in the case where the face thereof is occluded by an occluder, and Lₜₐₛₖ₋ₒₜₕₑᵣₛ₍₂₎ represents a loss between the predicted probability value and the true value for the second attribute of the person in the case where the face thereof is not occluded by an occluder. Again, after the loss sum L2 is calculated, the CPU 110 updates the parameters of each layer in each of the current second recognition neural network candidates, the current “feature extraction neural network”, and the current “first recognition neural network” based on the loss sum L2 in the manner of back propagation.

In another implementation, as for the second embodiment of the present disclosure, firstly, on the one hand, the CPU 110 passes the currently acquired training samples through the current “feature extraction neural network” (e.g., the “feature extraction neural network” updated via step S730) to obtain the “shared feature”, passes the “shared feature” through the current “first recognition neural network” (e.g., the “first recognition neural network” updated via step S730) to obtain the “saliency feature”, and passes the “saliency feature” through the current “first recognition neural network” to obtain the predicted probability value for the first attribute of the object. On the other hand, the CPU 110 performs the feature filtering operation on the “shared feature” by using the “saliency feature” to obtain the “filtered feature”. And for each candidate network among the second recognition neural network candidates, the CPU 110 passes the “filtered feature” through the current candidate network to obtain the predicted probability value for the second attribute of the object under this candidate network. Secondly, as described above, the CPU 110 determines each loss and calculates the loss sum L2, and updates the parameters of each layer in each of the current second recognition neural network candidates, the current “feature extraction neural network”, and the current “first recognition neural network” based on the loss sum L2.

Returning to FIG. 7, in step S780, the CPU 110 determines whether each of the current second recognition neural network candidates, the current “feature extraction neural network”, and the current “first recognition neural network” satisfy a predetermined condition. For example, after the number of updates for each of the current second recognition neural network candidates, the current “feature extraction neural network”, and the current “first recognition neural network” reaches a predetermined number of times (e.g., Z times), it is considered that each of the current second recognition neural network candidates, the current “feature extraction neural network”, and the current “first recognition neural network” have satisfied the predetermined condition, thereby outputting them as final neural networks to the storage device 240 illustrated in FIGS. 2 and 4 for example; otherwise, the generation process re-proceeds to step S770. However, it is obviously not necessary to be limited thereto. It is also possible to determine whether each of the current neural networks satisfies a predetermined condition based on the calculated loss sum L2 and a predetermined threshold (e.g., TH3), as described above in the replacement solutions for the steps S710 and S720. Since the corresponding determination operations are similar, the detailed description will not be repeated here.

All of the units described above are exemplary and/or preferred modules for implementing the processing described in this disclosure. These units may be hardware units, such as field programmable gate arrays (FPGAs), digital signal processors, application specific integrated circuits, etc., and/or software modules, such as computer readable programs. The units for implementing each of the steps are not described exhaustedly above. However, when there is a step to perform a particular process, there may be a corresponding functional module or unit (implemented by hardware and/or software) for implementing the same process. The technical solutions of all combinations of the steps described and the units corresponding to these steps are included in the disclosed content of the present application, as long as the technical solutions constituted by them are complete and applicable.

The method and apparatus of the present disclosure may be implemented with a plurality of manners. For example, the method and apparatus of the present disclosure may be implemented by software, hardware, firmware, or any combination thereof. The above described order of steps of the present method is intended to be merely illustrative, and the steps of the method of the present disclosure are not limited to the order specifically described above, unless specified otherwise. Furthermore, in some embodiments, the present disclosure may also be implemented as a program recorded in a recording medium, which includes machine readable instructions for implementing the method according to the invention. Accordingly, the present disclosure also encompasses a recording medium storing a program for implementing the method according to the present disclosure.

While some specific embodiments of the present disclosure have been shown in detail by way of examples, it is to be appreciated by those skilled in the art that the above examples are intended to be merely illustrative and do not limit the scope of the invention. It is to be appreciated by those skilled in the art that the above embodiments may be modified without departing from the scope and spirit of the present disclosure. The scope of the present disclosure is restricted by the appended claims.

What is claimed is:

1. An attribute recognition apparatus, comprising:
an extraction unit that extracts a first feature from an image by using a feature extraction neural network;
a first recognition unit that recognizes a first attribute of an object in the image based on the first feature by using a first recognition neural network;
a determination unit that determines a second recognition neural network from a plurality of second recognition neural network candidates based on the first attribute; and
a second recognition unit that recognizes at least one second attribute of the object based on the first feature by using the second recognition neural network.

2. The attribute recognition apparatus according to claim 1, wherein the first recognition unit comprises:
a first generation unit that generates a feature associated with the first attribute based on the first feature by using the first recognition neural network; and
a classification unit that recognizes the first attribute based on the feature associated with the first attribute by using the first recognition neural network.

3. The attribute recognition apparatus according to claim 2, further comprising:
a second generation unit that generates a second feature based on the first feature and the feature associated with the first attribute,
wherein the second recognition unit recognizes at least one second attribute of the object based on the second feature by using the second recognition neural network.

4. The attribute recognition apparatus according to claim 3, wherein the second feature is a feature associated with at least one second attribute of the object to be recognized by the second recognition unit.

5. The attribute recognition apparatus according to claim 2, wherein the first attribute is whether the object is occluded by an occluder, and wherein the feature associated with the first attribute embodies a probability distribution of the occluder.

6. The attribute recognition apparatus according to claim 1, wherein the feature extraction neural network and the first recognition neural network are updated simultaneously in a manner of back propagation based on training samples which are labeled with the first attribute.

7. The attribute recognition apparatus according to claim 6, wherein, for each of the second recognition neural network candidates, the second recognition neural network, the feature extraction neural network and the first recognition neural network are updated simultaneously in the manner of back propagation based on training samples in which labels correspond to a category of the first attribute.

8. The attribute recognition apparatus according to claim 7, wherein each of the second recognition neural network candidates, the feature extraction neural network and the first recognition neural network are updated simultaneously in the manner of back propagation based on training samples which are labeled with the first attribute.

9. The attribute recognition apparatus according to claim 8, wherein each of the second recognition neural network candidates, the feature extraction neural network and the first recognition neural network are updated by determining a loss which is caused by passing training samples, which are labeled with the first attribute, through these neural networks;
wherein a recognition result obtained by the feature extraction neural network and the first recognition neural network is used as a parameter for determining a loss caused by each of the second recognition neural network candidates.

10. An attribute recognition method, comprising:
an extracting step of extracting a first feature from an image by using a feature extraction neural network;
a first recognizing step of recognizing a first attribute of an object in the image based on the first feature by using a first recognition neural network;
a determination step of determining a second recognition neural network from a plurality of second recognition neural network candidates based on the first attribute; and
a second recognizing step of recognizing at least one second attribute of the object based on the first feature by using a second recognition neural network.

11. The attribute recognition method according to claim 10, wherein the first recognizing step comprises:
a first generating step of generating a feature associated with the first attribute based on the first feature by using the first recognition neural network; and
a classifying step of recognizing the first attribute based on the feature associated with the first attribute by using the first recognition neural network.

12. The attribute recognition method according to claim 11, further comprising:
a second generating step of generating a second feature based on the first feature and the feature associated with the first attribute;
wherein, in the second recognizing step, at least one second attribute of the object is recognized based on the second feature by using the second recognition neural network.

13. The attribute recognition method according to claim 12, wherein the second feature is a feature associated with at least one second attribute of the object to be recognized by the second recognizing step.

14. The attribute recognition method according to claim 11, wherein the first attribute is whether the object is occluded by an occluder, and wherein the feature associated with the first attribute embodies a probability distribution of the occluder.

15. A non-transitory computer-readable storage medium storing an instruction for, when executed by a processor, enabling the attribute recognition method comprising:
an extracting step of extracting a first feature from an image by using a feature extraction neural network;
a first recognizing step of recognizing a first attribute of an object in the image based on the first feature by using a first recognition neural network;
a determination step of determining a second recognition neural network from a plurality of second recognition neural network candidates based on the first attribute; and
a second recognizing step of recognizing at least one second attribute of the object based on the first feature by using a second recognition neural network.
